(19) United States
(12) Patent Application Publication
(10) Pub. No.: US 2026/0260552 A1
(43) Pub. Date: Sep. 3, 2026

(54) OBJECT INTRUSION DETECTION SYSTEM, DETECTION METHOD THEREFOR, AND PROGRAM

(71) Applicant: NEC Corporation, Tokyo (JP)

(72) Inventor: Taisuke SHIMADA, Tokyo (JP)

(73) Assignee: NEC Corporation, Tokyo (JP)

(21) Appl. No.: 19/162,128

(22) PCT Filed: Dec. 13, 2023
(86) PCT No.: PCT/JP2023/044544

§ 371 Date: Sep. 4, 2025

(30) Foreign Application Priority Data
Mar. 16, 2023 (JP) 2023-042271

(51) Int. Cl. G08B 13/12; G01H 9/00

(52) U.S. Cl. CPC G08B 13/124; G01H 9/004

(57) ABSTRACT

To make it possible to minimize false detection of an intruder. This object intrusion detection system comprises a first optical fiber for detecting vibration, a second optical fiber that is disposed at a height position different from that of the first optical fiber and that detects vibration, and an intruding object detection unit that determines whether a detection is a false detection in accordance with the number of optical fibers in which a vibration is detected.

### TECHNICAL FIELD

The present disclosure relates to an object intrusion detection system for detecting an intrusion of an object, a detection method therefor, and a program.

### BACKGROUND ART

In order to suppress false detection of an intruder, there is known a system that changes a voltage to a threshold voltage according to a variance value of a sensor voltage and compares the threshold voltage with the sensor voltage to detect an object (see e.g., PTL 1).

### CITATION LIST

### Patent Literature

PTL 1: JP 2012-118004 A

### SUMMARY OF INVENTION

### Technical Problem

By the way, in the above system, it is necessary to detect an object by changing the threshold voltage, and thus, the configuration may become complicated.

An object of the present disclosure is to provide an object intrusion detection system, a detection method therefor, and a program that solve any of the above-described problems.

### Solution to Problem

One aspect of the present disclosure for achieving the above object is an object intrusion detection system including:
a first optical fiber for detecting a vibration,
a second optical fiber that is disposed at a height position different from that of the first optical fiber and that detects a vibration, and
an intruding object detection unit that determines whether a detection is a false detection according to number of optical fibers in which a vibration is detected.

One aspect of the present disclosure for achieving the above object is a detection method of an object intrusion detection system including,
a first optical fiber for detecting a vibration, and
a second optical fiber that is disposed at a height position different from that of the first optical fiber and that detects a vibration, the method including:
determining whether a detection is a false detection according to number of optical fibers in which a vibration is detected.

One aspect of the present disclosure for achieving the above object is a program of an object intrusion detection system including,
a first optical fiber for detecting a vibration, and
a second optical fiber that is disposed at a height position different from that of the first optical fiber and that detects a vibration, the program causing a computer to execute processing of:
determining whether a detection is a false detection according to number of optical fibers in which a vibration is detected.

### Advantageous Effects of Invention

According to the present disclosure, an object intrusion detection system, a detection method therefor, and a program that solve any of the above-described problems can be provided.

### BRIEF DESCRIPTION OF DRAWINGS

FIG. 1 is a schematic diagram illustrating a schematic configuration of an object intrusion detection system according to the present example embodiment.

FIG. 2 is a flowchart illustrating a flow of a detection method of the object intrusion detection system according to the present example embodiment.

FIG. 3 is a schematic diagram illustrating a schematic configuration of the object intrusion detection system according to the present example embodiment.

FIG. 4 is a diagram illustrating a state in which a strong wind perpendicularly crosses a measurement point F_{2, 2} of a second optical fiber and a measurement point F_{1, 2} of a first optical fiber in this order.

FIG. 5 is a diagram illustrating waveforms of vibration values at measurement points of the first and second optical fibers when a strong wind crosses.

FIG. 6 is a diagram illustrating a state in which a strong wind diagonally crosses a measurement point F_{1, 1} of the first optical fiber and a measurement point F_{2, 2} of a second optical fiber in this order.

FIG. 7 is a diagram illustrating waveforms of vibration values at measurement points of the first and second optical fibers when a strong wind diagonally crosses.

FIG. 8 is a schematic diagram illustrating a schematic configuration of the object intrusion detection system according to the present example embodiment.

### EXAMPLE EMBODIMENT

Hereinafter, the present example embodiment will be described through example embodiments of the invention, but the invention according to the claims is not limited to the following example embodiments. Not all the configurations described in the example embodiments are essential as means for solving the problem.

### First Example Embodiment

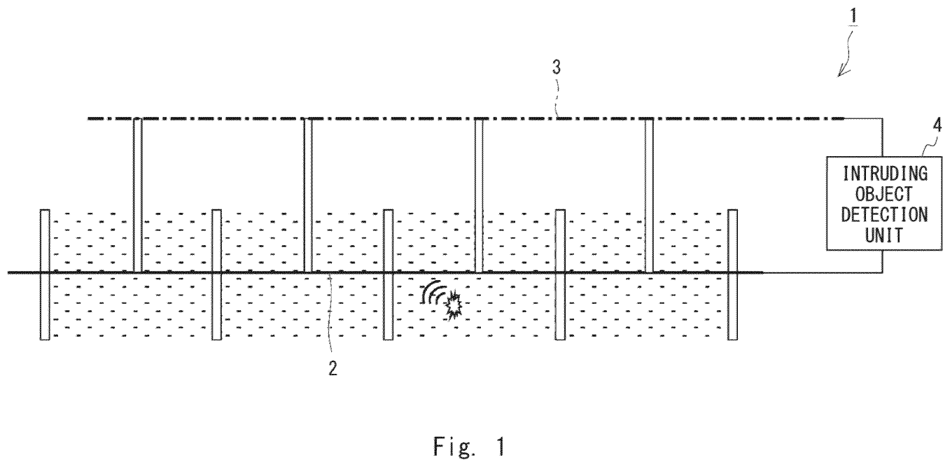

FIG. 1 is a schematic diagram illustrating a schematic configuration of an object intrusion detection system according to the present example embodiment. An object intrusion detection system 1 according to the present example embodiment includes a first optical fiber 2, a second optical fiber 3, and an intruding object detection unit 4.

The first optical fiber 2 is, for example, laid along a boundary line of an outer peripheral fence, a wall, or the like of a facility. The first optical fiber 2 is laid to detect an intruder such as a person or an animal intruding beyond a boundary line such as the outer peripheral fence. For this reason, for example, the first optical fiber 2 is preferably disposed at a height position at which vibration by an intruder is easily detected.

By the way, although the first optical fiber 2 vibrates due to strong wind, construction, traveling of a train, an airplane, an automobile (highway), or the like, the vibration may be determined to be caused by an intruder, and the intruder may be falsely detected.

On the other hand, in the present example embodiment, the second optical fiber 3 is laid in order to suppress false detection of an intruder by the first optical fiber 2. The second optical fiber 3 may be laid in parallel to the first optical fiber 2 at a height position different from that of the first optical fiber 2.

For example, when the cause of the false detection is strong wind, the second optical fiber 3 may be disposed at a predetermined height position that is easily affected by the strong wind and is not touched by a person or the like. The second optical fiber 3 is attached to a support column or the like and is laid at the predetermined height position. On the other hand, when the cause of the false detection is construction, a train, an airplane, an automobile, or the like, the second optical fiber 3 may be buried under the ground where it is easily affected by the vibration.

As illustrated in FIG. 1, the second optical fiber 3 is laid in parallel to the first optical fiber 2 while being spaced apart from the first optical fiber 2 by a predetermined distance in the inner side direction of the boundary line. By laying in such a manner, both the first and second fibers vibrate with respect to strong wind moving across the first and second optical fibers 2 and 3. On the other hand, only the first optical fiber 2 vibrates with respect to the intrusion of the intruder to within the boundary line.

The intruding object detection unit 4 detects intrusion of an intruder into the boundary line based on the characteristics of the first and second optical fibers 2 and 3. That is, in a case where vibration is detected only by the first fiber, the intruding object detection unit 4 detects intrusion of an intruder into the boundary line due to the vibration.

On the other hand, in a case where vibration is detected by the first fiber and the second optical fiber 3, the intruding object detection unit 4 determines as false detection due to strong wind or the like, and does not detect intrusion of an intruder into the boundary line due to the vibration. In this manner, it is possible to clearly distinguish whether the vibration of the first optical fiber 2 is caused by strong wind or the like or by an intruder, by the vibration of the second optical fiber 3. As a result, false detection of an intruder can be suppressed.

The intruding object detection unit 4 has a hardware configuration of a normal computer including, for example, a processor such as a central processing unit (CPU) or a graphics processing unit (GPU), an internal memory such as a random access memory (RAM) or a read only memory (ROM), a storage device such as a hard disk drive (HDD) or a solid state drive (SDD), an input/output I/F for connecting a peripheral device such as a display, and a communication I/F for communicating with a device outside the device.

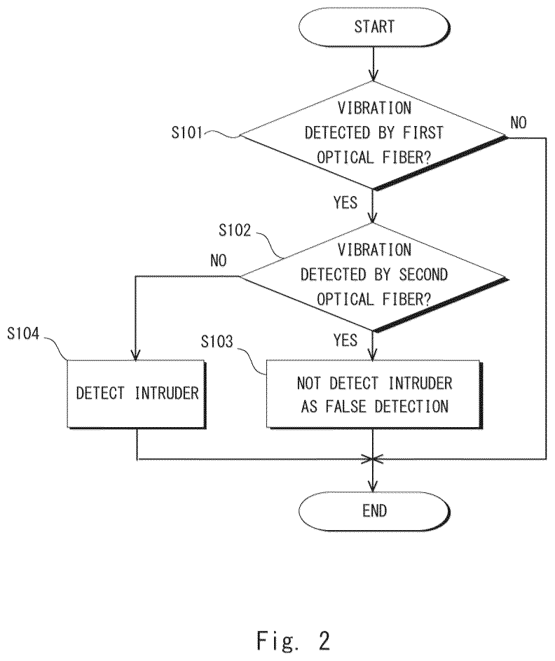

Next, a detection method of the object intrusion detection system according to the present example embodiment described above will be described. FIG. 2 is a flowchart illustrating a flow of a detection method of the object intrusion detection system according to the present example embodiment.

The intruding object detection unit 4 determines whether vibration is detected by the first optical fiber 2 (step S101).

When determining that the vibration has been detected by the first optical fiber 2 (YES in step S101), the intruding object detection unit 4 determines whether the vibration is detected by the second optical fiber 3 (step S102). On the other hand, when determining that no vibration has been detected by the first optical fiber 2 (NO in step S101), the intruding object detection unit 4 ends the present processing.

When determining that vibration has been detected by the second optical fiber 3 (YES in step S102), the intruding object detection unit 4 determines as false detection due to strong wind or the like, and does not detect intrusion of an intruder to within the boundary line due to the vibration (step S103). On the other hand, when determining that no vibration has been detected by the second optical fiber 3 (NO in step S102), the intruding object detection unit 4 detects intrusion of an intruder into the boundary line due to the vibration.

As described above, in the object intrusion detection system 1 according to the present example embodiment, when vibration is detected only by the first optical fiber 2, the intruding object detection unit 4 detects intrusion of an intruder into a boundary line due to the vibration. Furthermore, when vibration is detected by the first optical fiber 2 and the second optical fiber 3, the intruding object detection unit 4 determines as false detection due to strong wind or the like, and does not detect intrusion of an intruder into the boundary line due to the vibration. As a result, false detection of an intruder due to strong wind or the like can be suppressed.

In the example embodiment described above, the number of optical fibers is two, the first and second optical fibers 2 and 3, but this is not the sole case, and the number of optical fibers may be three or more. When the number of optical fibers in which vibration is detected is larger than a predetermined number, the intruding object detection unit 4 may determine as false detection.

In addition, in the example embodiment described above, the predetermined number is one, but in the present modified example, the predetermined number may be, for example, two or three or more, and may be arbitrarily determined by the user. The predetermined number may be determined according to an event to be detected as false detection or a type of an object.

### Second Example Embodiment

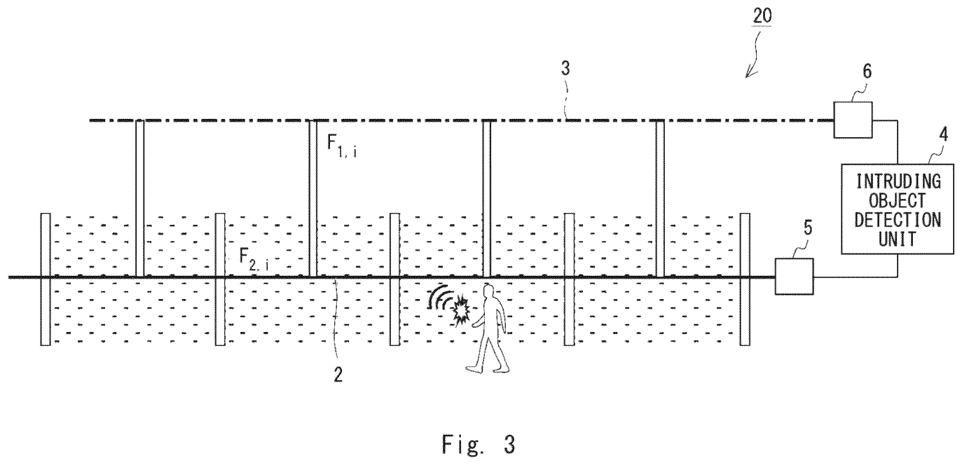

FIG. 3 is a schematic diagram illustrating a schematic configuration of the object intrusion detection system according to the present example embodiment. The object intrusion detection system 20 according to the present example embodiment further includes a first optical fiber sensor 5 and a second optical fiber sensor 6 in addition to the above configuration.

The first optical fiber sensor 5 is provided at an end portion of the first optical fiber 2. The first optical fiber sensor 5 measures the strain AL of the first optical fiber 2 through the phase difference Ao of the backscattering light in the gauge length section. The first optical fiber 2 operates as an independent vibration sensor in each gauge length section. The first optical fiber sensor 5 transmits a pulse-shaped optical signal to the first optical fiber 2, and detects a vibration value of each measurement point based on a reflection signal from each measurement point on the first optical fiber 2.

Similarly, the second optical fiber sensor 6 is provided at an end portion of the second optical fiber 3. The second optical fiber sensor 6 transmits a pulse-shaped optical signal to the second optical fiber 3, and detects a vibration value of each measurement point based on a reflection signal from each measurement point on the second optical fiber 3.

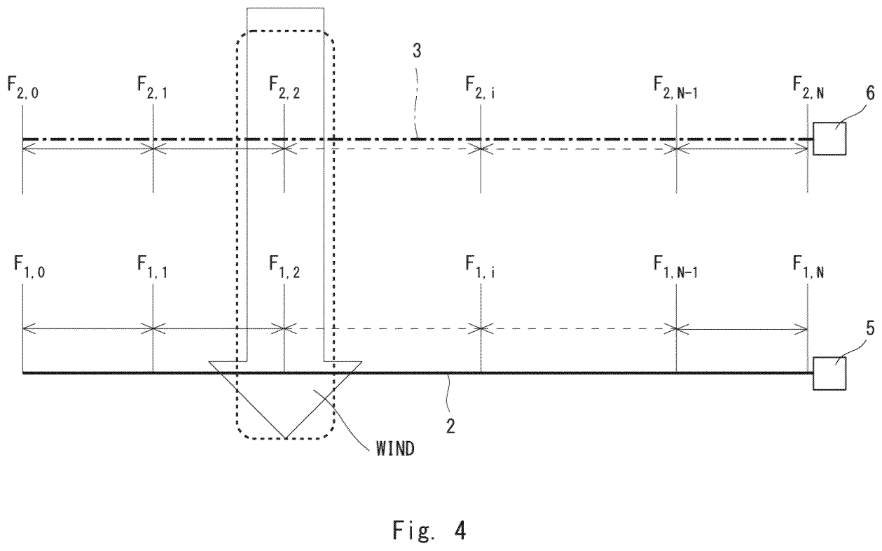

For example, as illustrated in FIG. 4, the first optical fiber sensor 5 detects the vibration value of each measurement points F_{1, 0}, . . . , F_{1, N} of the first optical fiber 2 at regular time intervals. The second optical fiber sensor 6 detects the vibration value of each measurement point F_{2, 0}, . . . , F_{2, i}, . . . , F_{2, N} of the second optical fiber 3 at regular time intervals.

It is assumed that each of the measurement points F_{1, 0}, . . . , F_{1, i}, . . . , F_{1, N} of the first optical fiber 2 corresponds to each of the measurement points F_{2, 0}, . . . , F_{2, N} of the second optical fiber 3.

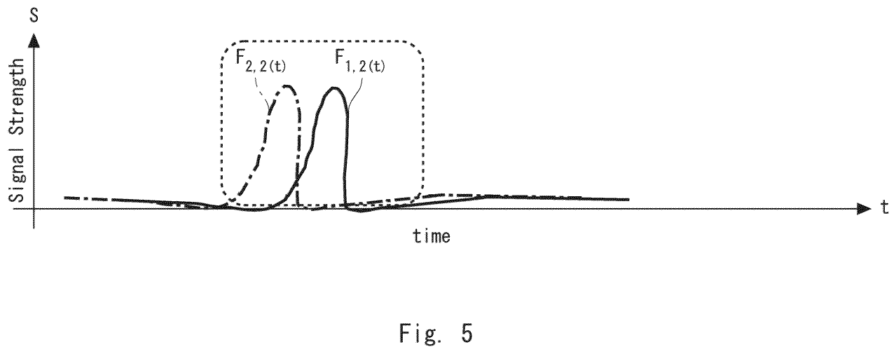

For example, as illustrated in FIG. 4, it is assumed that a strong wind perpendicularly crosses the measurement point F_{2, 2} of the second optical fiber 3 and the measurement point F_{1, 2} of the first optical fiber 2 in this order. FIG. 5 is a diagram illustrating waveforms of vibration values at the measurement points of the first and second optical fibers 2 and 3 when the strong wind crosses.

As illustrated in FIG. 5, the waveform F_{1, 2}(t) of the vibration value at the measurement point F_{1, 2} of the first optical fiber 2 and the waveform F_{2, 2}(t) of the vibration value at the measurement point F_{2, 2} of the second optical fiber 3 are the same or similar. Furthermore, the strong wind passes through the measurement point F_{2, 2} of the second optical fiber 3 and then passes through the measurement point F_{1, 2} of the first optical fiber 2. Therefore, the waveform F_{2, 2}(t) of the vibration value at the measurement point F_{2, 2} of the second optical fiber 3 is temporally ahead of the waveform F_{1, 2}(t) of the vibration value at the measurement point F_{1, 2} of the first optical fiber 2.

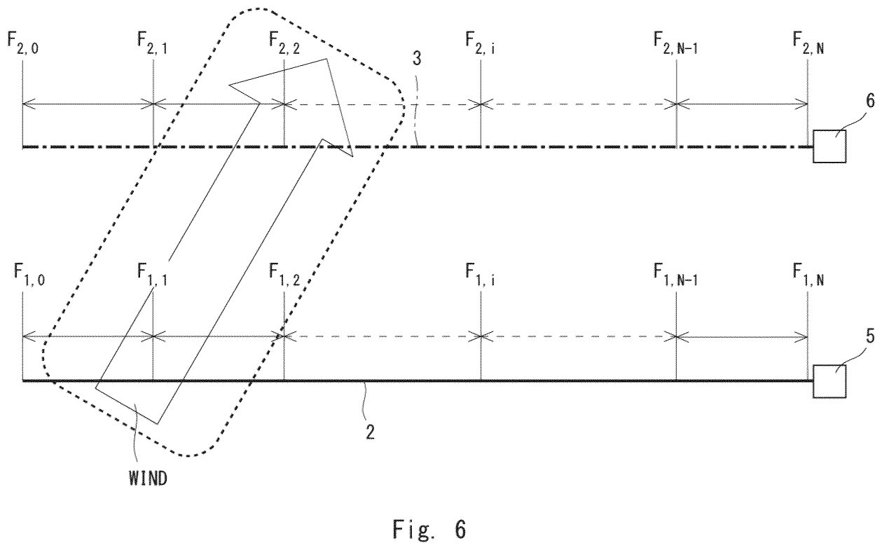

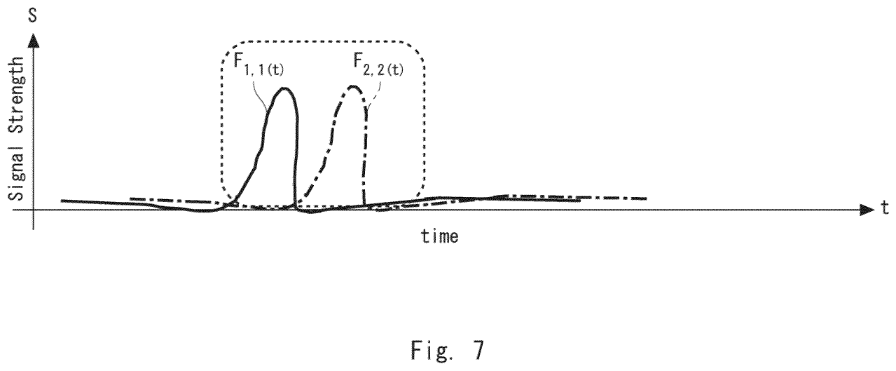

In addition, as illustrated in FIG. 6, it is also conceivable that a strong wind diagonally crosses the measurement point F_{1, 1} of the first optical fiber 2 and the measurement point F_{2, 2} of the second optical fiber 3 in this order. FIG. 7 is a diagram illustrating waveforms of vibration values at the measurement points of the first and second optical fibers 2 and 3 when the strong wind diagonally crosses.

In this case as well, as illustrated in FIG. 7, the waveform F_{1, 1}(t) of the vibration value at the measurement point F_{1, 1} of the first optical fiber 2 and the waveform F_{2, 2}(t) of the vibration value at the measurement point F_{2, 2} of the second optical fiber 3 are the same or similar. Furthermore, the strong wind passes through the measurement point F_{1, 1} of the first optical fiber 2 and then passes through the measurement point F_{2, 2} of the second optical fiber 3. Therefore, the waveform F_{1, 1}(t) of the vibration value at the measurement point F_{1, 1} of the first optical fiber 2 is temporally ahead of the waveform F_{2, 2}(t) of the vibration value at the measurement point F_{2, 2} of the second optical fiber 3.

From the above, in order to determine whether the waveform F_{1, i}(t) of the vibration of the measurement point F_{1, i} of the first optical fiber 2 is due to the wind or the intruder, the intruding object detection unit 4 checks whether the same or similar waveform of vibration is generated at the measurement point F_{2, i} of the corresponding second optical fiber 3 and the measurement point F_{2, i±a} within a predetermined distance from the measurement point F_{2, i} in a predetermined period p.

An experimentally obtained optimum value may be set for the value of a indicating how much the wind in the diagonal direction is to be considered and the value of p indicating how much past information is to be checked.

In a case where the waveform F_{1, i}(t) of the vibration value of the measurement point F_{1, i} of the first optical fiber 2 and the waveform of at least one measurement point of the measurement point F_{2, i} of the corresponding second optical fiber 3 and the measurement points F_{2, i±a} within a predetermined distance from the measurement point F_{2, i} are the same or similar in the predetermined period p, the intruding object detection unit 4 does not detect intrusion of an intruder into the boundary line due to vibration of the measurement point F_{1, i} as false detection due to strong wind.

In this manner, it is possible to clearly distinguish whether the vibration of the first optical fiber 2 is caused by strong wind or the like, or by an intruder, by comparing the waveform of the vibration value of the measurement point of the first optical fiber 2 with the waveform of the corresponding measurement point of the second optical fiber 3 and the waveform of the measurement point within a predetermined distance from the measurement point. As a result, false detection of an intruder can be suppressed with higher accuracy.

In the above description, the case where the cause of the false detection is strong wind has been described, but the case where the cause of the false detection is construction, a train, an airplane, an automobile, or the like is the same as the case of the strong wind, and thus a detailed description thereof will be omitted.

### Third Example Embodiment

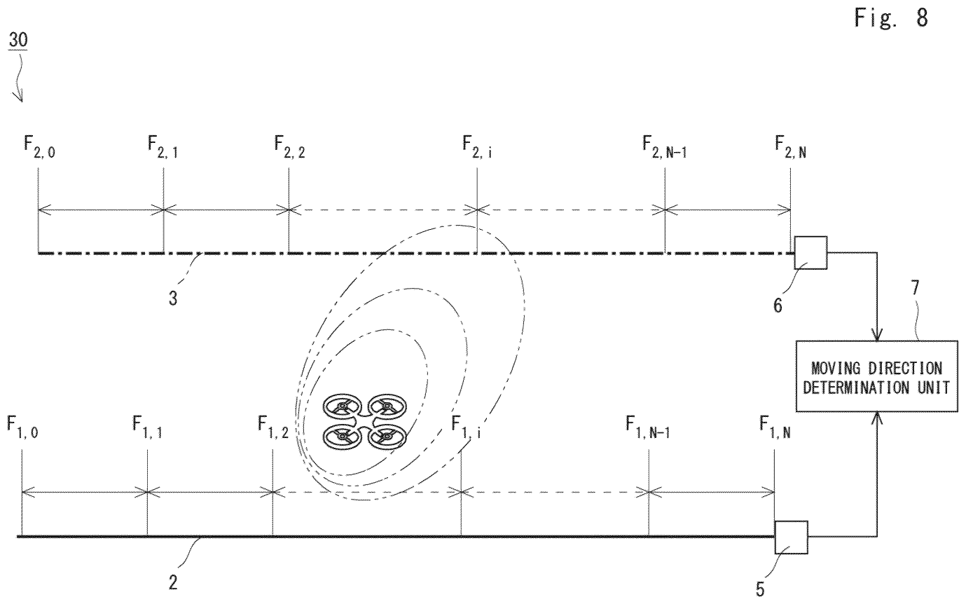

FIG. 8 is a schematic diagram illustrating a schematic configuration of the object intrusion detection system according to the present example embodiment. The object intrusion detection system 30 according to the third example embodiment further includes a moving direction determination unit 7 for determining the moving direction of the object in addition to the above configuration.

For example, when a moving object such as a drone moves between the first and second optical fibers 2 and 3 toward the first optical fiber 2 side while emitting a sound such as a propeller sound, the frequency of the vibration at each measurement point of the first optical fiber 2 increases and the frequency of the vibration at each measurement point of the second optical fiber 3 decreases due to the Doppler effect.

Using the properties of the Doppler effect as described above, the moving direction determination unit 7 compares the frequency of the vibration at the measurement point of the first optical fiber 2 with the frequency of the vibration at the measurement point of the second optical fiber 3. Then, the moving direction determination unit 7 determines that the object that generates the vibration is moving in the direction of the optical fiber in the high direction among the frequencies of the vibrations at the measurement points of the first and second optical fibers 2 and 3.

For example, when determining that the frequency of the vibration at the measurement point of the first optical fiber 2 is higher than the frequency of the vibration at the measurement point of the second optical fiber 3, the moving direction determination unit 7 determines that the object of the vibration is moving in the direction of the first optical fiber 2. In this manner, the moving direction of the object that generates the sound can be easily determined by merely comparing the frequencies of the vibrations of the measurement points of the first and second optical fibers 2 and 3.

The object intrusion detection system 30 may warn the object moving from the first optical fiber 2 to the second optical fiber 3, for example, based on the moving direction of the object determined by the moving direction determination unit 7.

Although several example embodiments of the present disclosure have been described, these example embodiments have been presented as examples, and are not intended to limit the scope of the invention. These novel example embodiments can be implemented in various other forms, and various omissions, substitutions, and changes can be made within a scope not deviating from the gist of the invention. These example embodiments and modified examples thereof are included in the scope and gist of the invention, and are included in the invention described in the claims and the equivalent scope thereof.

According to the present disclosure, for example, the processing illustrated in FIG. 2 can also be implemented by causing a processor to execute a computer program.

The program includes a group of commands (or software code) for causing a computer to perform one or more functions described in the example embodiments when the program is loaded into the computer. The program may be stored in a non-transitory computer-readable medium or a tangible storage medium. As an example, and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted through a transitory computer-readable medium or a communication medium. As an example, and not by way of limitation, a transitory computer-readable or communication medium includes electrical, optical, acoustic, or other forms of propagated signals.

Some or all of the above-described example embodiments may be described as the following Supplementary Notes, but are not limited to the following Supplementary Notes.

### Supplementary Note 1

An object intrusion detection system including:
a first optical fiber for detecting a vibration,
a second optical fiber that is disposed at a height position different from that of the first optical fiber and that detects a vibration, and
an intruding object detection unit that determines whether a detection is a false detection according to number of optical fibers in which a vibration is detected.

### Supplementary Note 2

The object intrusion detection system according to supplementary note 1, in which the intruding object detection unit determines as a false detection in a case where the number of optical fibers in which a vibration is detected is larger than a predetermined number.

### Supplementary Note 3

The object intrusion detection system according to supplementary note 1, in which
the second optical fiber is laid in parallel at a height position different from a height position of the first optical fiber, and
the object intrusion detection system further includes,
a first optical fiber sensor for transmitting an optical signal to the first optical fiber and detecting a vibration value of each measurement point based on a reflection signal from each measurement point on the first optical fiber, and
a second optical fiber sensor for transmitting an optical signal to the second optical fiber and detecting a vibration value of each measurement point based on a reflection signal from each measurement point on the second optical fiber.

### Supplementary Note 4

The object intrusion detection system according to supplementary note 3, in which the intruding object detection unit determines, when a waveform of a vibration value of a measurement point of the first optical fiber and a waveform of at least one measurement point of a corresponding measurement point of the second optical fiber and a measurement point within a predetermined distance from the measurement point are the same or similar in a predetermined period, as false detection, and does not detect intrusion of an object due to the vibration value.

### Supplementary Note 5

The object intrusion detection system according to any one of supplementary notes 1 to 4, further including a moving direction determination unit that determines a moving direction of an object by comparing a frequency of a vibration detected by the first optical fiber and a frequency of a vibration detected by the second optical fiber.

### Supplementary Note 6

A detection method of an object intrusion detection system including,
a first optical fiber for detecting a vibration, and
a second optical fiber that is disposed at a height position different from that of the first optical fiber and that detects a vibration, the method including:
determining whether a detection is a false detection according to number of optical fibers in which a vibration is detected.

### Supplementary Note 7

A program of an object intrusion detection system including,
a first optical fiber for detecting a vibration, and
a second optical fiber that is disposed at a height position different from that of the first optical fiber and that detects a vibration, the program causing a computer to execute processing of:
determining whether a detection is a false detection according to number of optical fibers in which a vibration is detected.

### REFERENCE SIGNS LIST

1 object intrusion detection system
2 first optical fiber
3 second optical fiber
4 intruding object detection unit
5 first optical fiber sensor
6 second optical fiber sensor
7 moving direction determination unit
20 object intrusion detection system
30 object intrusion detection system

What is claimed is:

1. An object intrusion detection system comprising:
a first optical fiber for detecting a vibration;
a second optical fiber that is disposed at a height position different from that of the first optical fiber and that detects a vibration; and
an intruding object detection unit that determines whether a detection is a false detection according to number of optical fibers in which a vibration is detected.

2. The object intrusion detection system according to claim 1, wherein the intruding object detection unit determines as a false detection in a case where the number of optical fibers in which a vibration is detected is larger than a predetermined number.

3. The object intrusion detection system according to claim 1, wherein
the second optical fiber is laid in parallel at a height position different from a height position of the first optical fiber, and
the object intrusion detection system further includes,
a first optical fiber sensor for transmitting an optical signal to the first optical fiber and detecting a vibration value of each measurement point based on a reflection signal from each measurement point on the first optical fiber, and
a second optical fiber sensor for transmitting an optical signal to the second optical fiber and detecting a vibration value of each measurement point based on a reflection signal from each measurement point on the second optical fiber.

4. The object intrusion detection system according to claim 3, wherein the intruding object detection unit determines, when a waveform of a vibration value of a measurement point of the first optical fiber and a waveform of at least one measurement point of a corresponding measurement point of the second optical fiber and a measurement point within a predetermined distance from the measurement point are the same or similar in a predetermined period, as false detection, and does not detect intrusion of an object due to the vibration value.

5. The object intrusion detection system according to claim 1, further comprising a moving direction determination unit that determines a moving direction of an object by comparing a frequency of a vibration detected by the first optical fiber and a frequency of a vibration detected by the second optical fiber.

6. A detection method of an object intrusion detection system including,
a first optical fiber for detecting a vibration, and
a second optical fiber that is disposed at a height position different from that of the first optical fiber and that detects a vibration, the method comprising:
determining whether a detection is a false detection according to number of optical fibers in which a vibration is detected.

7. A program of an object intrusion detection system including,
a first optical fiber for detecting a vibration, and
a second optical fiber that is disposed at a height position different from that of the first optical fiber and that detects a vibration, the program causing a computer to execute processing of:
determining whether a detection is a false detection according to number of optical fibers in which a vibration is detected.
